(19) United States
(12) Patent Application Publication
(10) Pub. No.: US 2011/0272439 A1
(43) Pub. Date: Nov. 10, 2011

(54) Discharge structure for a liquid container

(75) Inventor: Hiroyuki Kuboshima, Shinagawa-ku (JP)

(73) Assignee: Florex Co., Ltd.

(21) Appl. No.: 12/800,033

(22) Filed: May 6, 2010

(51) Int. Cl. B65D 25/40; B67D 7/06

(52) U.S. Cl. 222/501; 222/562

(57) ABSTRACT

A discharge structure for a liquid container for, for instance, instant adhesive agents, including a container casing having a nozzle opening, a nozzle open/close member integrally made of plastic material and having a spring portion and an open/close rod extending from the spring portion and elastically urged toward the nozzle opening, and a cap detachably fitted on the container. The cap has an abutting section at its inside deep end so as to push the projecting tip end of the tapered end of the open/close rod into the nozzle opening and contacts the nozzle opening to close it. The nozzle opening is opened during the process of removal of the cap to release inside high pressure and then closed by the tapered end, thus preventing abrupt discharge of the inside adhesive when the tapered end is pushed into the nozzle opening upon use.

### BACKGROUND OF THE INVENTION

1. Field of the Invention

The present invention relates a liquid container and more particularly to a discharge structure for a liquid container containing therein low-viscosity liquid such as an instant adhesive or the like.

2. Description of the Related Art

The Japanese Utility Model Application Publication (Kokoku) No. S47-34599, for instance, discloses a conventional technology on a container for a liquid adhesive or the like. This container contains therein an adhesive or the like; and when an ejection nozzle is pressed against a target location and a rod or needle projecting out of the tip end of the ejection nozzle is elastically pushed back into the container, the tip end of the nozzle is opened, and the liquid adhesive or the like inside the container is ejected and applied to the target location.

Furthermore, the Japanese Utility Model Application Laid-Open (Kokai) No. S58-43977, for instance, discloses a spring that elastically presses such type of rod or needle as described above provided inside a nozzle of the container toward the tip end of the nozzle. Furthermore, a pencil-type container that employs a mechanism described above and that is covered by a cap detachably fitted to its entire nozzle section is also know well.

However, with the above-described pencil-type application container with a cap, when, for example, taking the cap off, pressing the nozzle against the target location, and applying the instant adhesive, an abrupt discharge of adhesive occasionally occurs as soon as the cap is removed due to the internal pressure caused by high outside temperature or vaporization of the volatile adhesive, and the result is application of the adhesive to unintended locations or non-application of the adhesive to the target location.

### BRIEF SUMMARY OF THE INVENTION

The present invention is to solve such problems with the existing containers, and it is an object of the present invention to provide a container in which, when the cap is removed, the pressure inside the container is released to the outside in advance, so that when the liquid such as adhesive is applied, the kind of discharge seen in the existing containers is prevented when the nozzle is opened.

It is another object of the present invention to provide a container in which the cap is screw-fitted to the container casing or to the nozzle so that the nozzle tip end and the bottom surface of the inside of the cap are in contact with each other tightly, so that when the cap is rotated and removed from the container casing or from the nozzle, the internal pressure of the container is released before the liquid inside the container casing is discharged.

Other objects and operations of the container according to the present invention will be made clear in the following detailed description of the present invention.

The above objects are accomplished by a unique structure of the present invention for a discharge structure for a liquid container that includes:
a container casing containing therein a liquid substance,
a nozzle member provided at a tip end of the container and having a nozzle section formed with a nozzle opening for dispensing therethrough the liquid substance contained in the container casing,
a nozzle open/close member having open/close rod that enters into the nozzle opening from an inner side thereof so that a tip end of the open/close rod projects out of a tip end of the nozzle section, the open/close rod opening and closing nozzle opening by elastically retreating and advancing in its axial direction, and
a cap detachably fitted on the nozzle section of the nozzle member;

and in the present invention, the cap is formed inside thereof with an abutting section that, when the cap is fitted on the nozzle member, pushes a projecting tip end of the open/close rod into the nozzle member overcoming an elastic force of the open/close rod and contacts the tip end of the nozzle section, thus closing plug the nozzle opening from an outside of the nozzle section.

In the above structure of the discharge structure according to the present invention, the container casing and the cap are engageable with each other by threaded portions and formed respectively thereon, so that the nozzle opening is opened and closed when the cap is rotated forwardly and reversely with respect to the container casing and thus advanced and retreated with respect to the container casing.

In addition, in the present invention, the abutting section of the cap is an interior abutting surface provided in a deep inside end of the cap that abuts an end surface of the nozzle section of the nozzle member.

The cap is provided with a handle formed on the outer surface of the cap so as to be used for rotating the cap with respect to the container casing.

In the present invention, the tip end of the open/close rod is tapered in a conical shape.

Furthermore, in the present invention, the nozzle open/close member includes, as a means for allowing the open/close rod to elastically advance and retreat, a spring portion formed by plastic material as a single unit with the open/close rod. This spring portion is installed inside the cap engaging section of the nozzle member.

In the discharge structure for a liquid container according to the present invention, the length L₁, which is a distance between the tip end surface of a sleeve and a tip end surface of the nozzle section of the nozzle member, and the length L₂, which is a distance between a base end surface and an interior abutting surface of the cap, is set so as to have a relationship of L₁≧L₂. With this configuration, the high internal pressure caused by the outside temperature and/or vaporization of the inside adhesive is released at the time of removal of the cap and thus abrupt discharge of the inside adhesive is prevented.

### BRIEF DESCRIPTION OF THE SEVERAL VIEWS OF THE DRAWINGS

FIG. 1 is an exploded perspective view showing a liquid discharge structure and the overall structure of a container according to the present invention; and

FIG. 2 is an enlarged cross-sectional view of the discharge structure of a container according to the present invention.

### DETAILED DESCRIPTION OF THE INVENTION

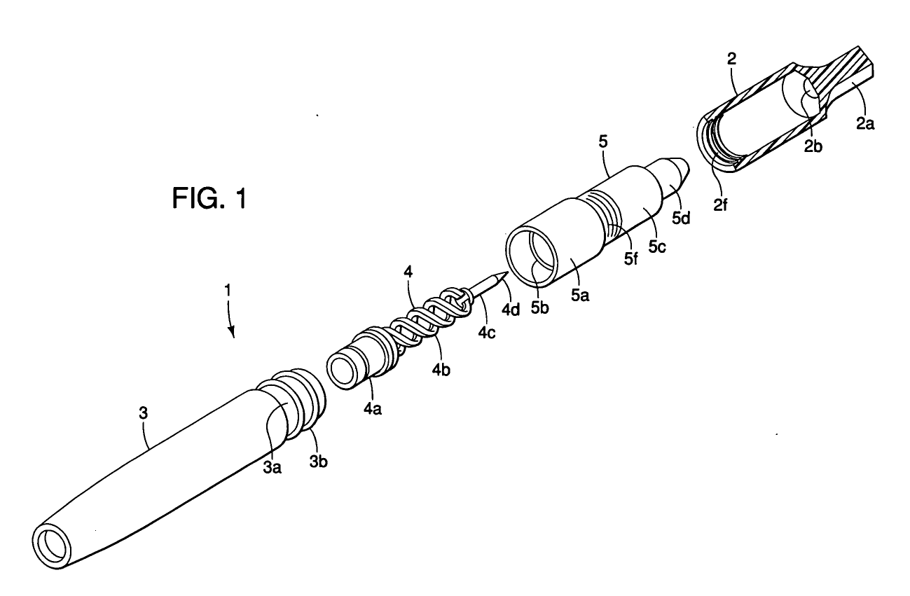

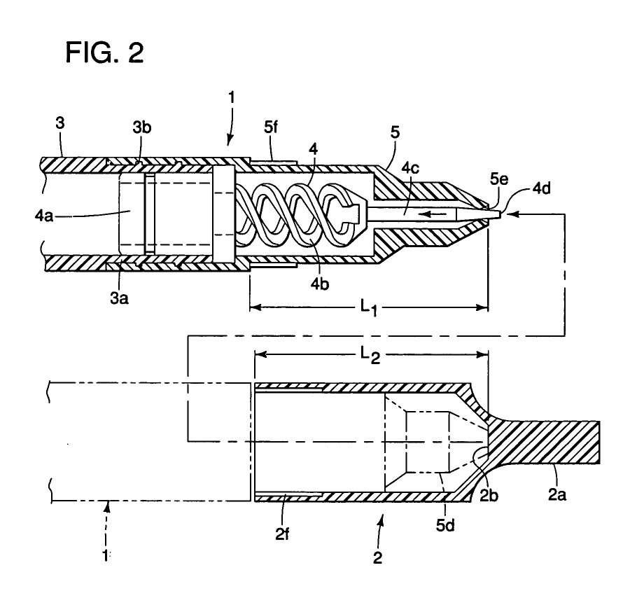

FIG. 1 and FIG. 2 show one embodiment of the liquid discharge structure for a container according to the present invention in which the present invention is applied to a pencil-type instant adhesive application container.

The entirety of the container is made of plastic having elasticity, and the container is comprised of a container main body 1 and a cap 2.

The container main body 1 comprises a cylindrical container casing 3 for storing a liquid adhesive inside, a nozzle open/close member 4 that is detachably fitted in the opening portion that is at the tip (front) end of this container casing 3, and a cylindrical nozzle member 5 which is hollow inside and is formed with a small nozzle opening 5e at its tip (front) end center.

The container casing 3 has at its tip (front) end a sleeve 3a formed to detachably engage with the inner periphery of the sleeve 5a that is formed at a base (rear) end of the nozzle member 5. More specifically, the sleeve 3a of the container casing 3 is formed on its outer surface with circular projections 3b and the sleeve 5a of the nozzle member 5 is formed on its inner surface with circular recesses 5b so that the circular projections 3b of the sleeve 3a and the circular recesses 5b of the nozzle member 5 form a detent structure and engaged with each other.

The nozzle open/close member 4 is comprised of a hollow sleeve 4a at the base (rear) end, a spring portion 4b which is formed in a coil-spring shape and extending forward from the sleeve 4a to the tip (front) end of the open/close member 4, and an open/close rod 4c provided at the tip (front) end of the spring portion 4b as to project at the tip end center of the open/close member 4. The tip (front) end of the open/close rod 4c is tapered so as to make a tapered needle section 4d. The entire body of the nozzle open/close member 4 is integrally made of a plastic material in a single unit. The sleeve 4a of the nozzle open/close member 4 is inserted into the sleeve (which is an engaging section) 3a of the container casing 3 up to a predetermined depth and detachably engaged therewith.

The nozzle member 5 is comprised of a sleeve 5a, a cap engaging section 5c, and a nozzle section 5d. More specifically, at the tip (front) end of the sleeve 5a of the nozzle member 5, the cap engaging section 5c with an incrementally decreasing diameter toward the tip (front) end of the nozzle member 5 is provided, and further a nozzle section 5d having a smaller diameter than the engaging section 5c is formed at the tip (front) end of the cap engaging section 5c. At the tip (front) end of the nozzle section 5d is formed a nozzle opening section 5g of a tapered shape, and the above-described nozzle opening 5e is opened at the center of this nozzle opening section 5g, so that the base end of the tapered needle section 4d can fitted to the inner circumference of the nozzle opening 5e, and the tapered needle section 4d is axially movable inside the nozzle opening 5e. Also, the tip (front) end of the nozzle opening 5g where the nozzle opening 5e is formed as a flat surface that is perpendicular to the axis line of the nozzle member 5. It is designed so that the tapered needle section 4d, when inserted into at its maximum depth, slightly projects out of the tip end of the nozzle opening section 5g or out of the nozzle opening 5e, and a ring-shaped gap is formed between the outer surface of the tapered needle section 4d and the inner circumference of the nozzle opening 5e, thus allowing the liquid adhesive to flow out through the gap.

When the sleeve (which is an engaging section) 5a of the nozzle member 5 is engaged with the container casing 3, the nozzle open/close member 4 is inside the nozzle member 5; and the tapered needle section 4d at the tip (front) end of the open/close rod 4c of the nozzle open/close member 4 is fitted at its base portion to the inner periphery of the nozzle opening 5e of the nozzle member 5 and engaged therewith since the open/close rod 4c is urged toward the tip (front) end of the nozzle element 5. In other words, the outer diameter of the base portion of the tapered needle section 4d is larger than the inner diameter of the nozzle opening 5e, and the outer diameter of the tapered needle section 4d becomes gradually smaller towards the tip end thereof.

As described above, in a state in which the container casing 3, the nozzle open/close member 4, and the nozzle member 5 are assembled on a same axis line, the tapered needle section 4d is elastically pushed against the nozzle opening 5e by the spring portion 4b of the nozzle open/close member 4 so that the nozzle opening Se is closed by the tapered needle section 4d. The nozzle opening Se is, however, opened when the projecting end of the tapered needle section 4d is pushed into the nozzle opening section 5g overcoming the spring force of the spring portion 4b, and as a result, the liquid material such as an adhesive agent or the like inside the container casing 3 leaches out.

Accordingly, when the tip end of the nozzle section 5d is pressed against an adhesive agent application surface, the adhesive inside the container casing 3 flows out through the ring-shaped gap between the tapered needle section 4d and the nozzle opening 5e and is applied to the surface against which the tip end of the nozzle section 5d is pressed.

The cap 2 can be attached to the container main body 1 or in more detail put on the nozzle member 5 thereof as described above. The cap 2 is substantially a cylinder with its tip (front) end closed and the base (rear) end opened so as to be detachably engaged with the outer periphery of the cap engaging section 5c of the nozzle member 5. The cap 2 is formed on its inner surface thereof with a threaded portion 2f, and the cap engaging section 5c of the nozzle member 5 is formed on its outer surface thereof with a threaded portion 5f, so that these threaded portions 2f and 5f are mutually thread-engaged and the cap 2 is mounted on the container main body 1.

When the cap 2 is put on the engaging section 5c of the nozzle member 5, and the cap 2 is rotated in one (forward) direction around its axis line with respect to the container casing 3 (or the nozzle member 5), the cap 2 is secured to the container main body 1 via the threaded portions 2f and 5f. When the cap 2 is rotated in anther (reverse) direction, then the cap 2 is removed from the container main body 1.

The tip (front) end of the cap 2 is notched to form a parallel flat surface to form a handle (knob) 2a for the rotation. This handle 2a thus formed on the outer surface of the cap 2 can be knurled, and it can take some other form. The deep inside end of the cap 2 is formed with an interior abutting surface 2b which is a flat surface perpendicular to the axis line of the cap 2.

This interior abutting surface 2b is formed so that when the cap 2 is screwed and mounted to the container casing 3 as shown in FIG. 2, the needle section 4d projecting out of the tip (front) end (or out of the nozzle opening 5e) of the nozzle section 5d is pushed elastically into the inside of the nozzle opening section 5g and the nozzle opening 5e is opened once (since the tapered needle section 4d is separated from the nozzle opening 5e), and before the end surface of the base (rear) end of the cap 2 abuts the tip (front) end surface of the sleeve 5a of the nozzle member 5, the interior abutting surface 2b of the cap 2 is pressed against the tip (front) end surface of the nozzle section 5d, so that the interior abutting surface 2b of the cap 2 closes or plugs the nozzle opening 5e. In other words, when the cap 2 is off the container main body 1 and no application of the inside adhesive is being performed, the nozzle opening 5e is closed by the tapered nozzle section 4d; and when the cap 2 is put on the container main body 1, then the nozzle opening 5e is closed by the interior abutting surface 2b of the cap 2.

To ensure this operation, as seen from FIG. 2, the length L₁, which is a distance between the tip (front) end surface of the sleeve 5a and the tip (front) end surface of the nozzle section 5d of the nozzle member 5, and the length L₂, which is a distance between the base (rear) end surface of the cap 2 and the interior abutting surface 2b of the cap 2, is set so as to have a relationship of L₁≧L₂.

Before use of the adhesive or the like with the cap 2 on the container casing 3, there are situations in which the internal pressure inside the container casing 3 becomes higher than the outside pressure due to, for example, the outside temperature or vaporization of the adhesive. In the present invention with the structure and setting as described above, at the moment when the interior abutting surface 2b of the cap 2 is separated from the end surface of the nozzle section in the process of removal of the cap 2, the nozzle opening 5e is opened between the tapered surface of the tapered needle section 4d (at the tip (front) end of the nozzle open/close member 4) and the nozzle opening 5e, and as a result, the high internal pressure of the container casing 3 is released through the nozzle opening 5e and to the outside of the cap 2 via the gap between the cap engaging section 5c (of the nozzle member 5) that has an incrementally decreasing diameter and the inner surface of the cap 2, and thus the internal pressure of the container casing 3 becomes equal to that of the outside. Accordingly, when the nozzle opening 5e is opened at a later time when application of the adhesive is made onto a target by pressing the tapered needle section 4d thereto, abrupt adhesive discharge of the inside adhesive caused by the high internal pressure in the container casing 3 is prevented.

When the air-tightness of the engagement of the cap 2 and the nozzle member 5 is high, it is possible to provide an air ventilation structure (not illustrated) such as small air venting hole(s) formed in the peripheral wall of the cap 2.

In the above embodiment, a description of the present invention is made for an instant adhesive container; however, the present invention is applicable to a container for other liquid material than adhesives, such as a container for applying or drawing lines of ink, liquid medication or the like.

As seen from the above, the present invention relates to a container used for, for example, applying or line-drawing a liquid material by way of pressing a needle or open/close rod-shaped member to allow the liquid material to be discharged from the container; and in such a container abrupt discharge of the content of the container due to high internal pressure inside the container is assuredly prevented, and this is accomplished by a simple structure. This is particularly desirable for application of liquid material, such as instant adhesives, for which application defects or uneven application is not permissible.

In addition, in the present invention, the nozzle opening is opened by rotating the cap by way of unscrewing of the cap from the nozzle member of the container main body; and upon this opening action of the nozzle opening, abrupt discharge of the liquid material (which is usually a large volume) inside the container that is caused by high internal pressure is prevented assuredly; and even if a certain volume of liquid material is discharged during the process of removal of the cap, this discharge occur only in the cap, and therefore, there is an advantage that problems such as adhering or spraying of the liquid material to the outside of the cap or the like can be prevented.

In addition, since the entire body of the nozzle open/close member is made of a plastic material in a single unit.

1. A discharge structure for a liquid container comprising:
a container casing containing therein a liquid substance,
a nozzle member provided at a tip end of the container casing and integrally formed with a sleeve and a nozzle section having a nozzle opening for dispensing therethrough the liquid substance contained in said container casing,
a nozzle open/close member integrally formed with a spring portion and an open/close rod that enters into the nozzle opening from an inner side thereof so that a tip end of the open/close rod projects out of a tip end of the nozzle section, the open/close rod opening and closing nozzle opening by elastically retreating and advancing in its axial direction, and
a cap detachably fitted on said nozzle section of said nozzle member;
wherein said cap is formed inside thereof with an abutting section that, when said cap is fitted on said nozzle section, pushes a projecting tip end of said open/close rod into said nozzle section overcoming an elastic force of said open/close rod and contacts the tip end of the nozzle section, thus closing the nozzle opening from an outside of said nozzle section.

2. The discharge structure for a liquid container according to claim 1, wherein said container casing and said cap are engageable with each other by threaded portions formed respectively thereon, so that said nozzle opening is opened and closed when said cap is rotated forwardly and reversely with respect to the container casing and thus advanced and retreated with respect to the container casing.

3. The discharge structure for a liquid container according to claim 1, wherein the abutting section of said cap is an interior abutting surface provided on an inside end of said cap that abuts an end surface of the nozzle section of said nozzle member.

4. The discharge structure for a liquid container according to claim 1, wherein said cap is provided with a handle formed on an outer surface of said cap for rotating said cap with respect to said container casing.

5. The discharge structure for a liquid container according to claim 1, wherein the open/close rod of said nozzle open/close member is formed as a needle section tapered in a conical shape.

6. The discharge structure for a liquid container according to claim 1, wherein said nozzle open/close member includes a spring portion formed by plastic material into a single unit with said open/close rod, said spring portion allowing said open/close rod to elastically advance and retreat.

7. The discharge structure for a liquid container according to claim 1, wherein a length L₁, which is a distance between a tip end surface of the sleeve and a tip end surface of the nozzle section of the nozzle member, and a length L₂, which is a distance between a base end surface and an interior abutting surface of said cap, is set so as to have a relationship of L₁≧L₂.
